(19) United States
(12) Patent Application Publication
(10) Pub. No.: US 2004/0036258 A1
(43) Pub. Date: Feb. 26, 2004

(54) Wheelchair

(76) Inventor: Terry D. Pleasant, Little Rock, AR (US)

Correspondence Address: Stephen R. Greiner, Esquire, GREINER LAW OFFICES, P.C., Suite 110, 6701 Democracy Blvd., Bethesda, MD, 20817, US

(21) Appl. No.: 10/225,539

(22) Filed: Aug. 22, 2002

(51) Int. Cl. B62B 1/00

(52) U.S. Cl. 280/648

(57) ABSTRACT

A wheelchair including a collapsible frame with rearward and forward portions that can be pivoted towards each other for compact storage. The collapsible frame rides on a pair of casters at its front and a pair of drive wheels at its rear. The positioning of a seat, footrest and a pair of armrests on the collapsible frame may be selectively varied to accommodate any user.

### FIELD OF THE INVENTION

The present invention relates generally to land vehicles and, more particularly, to wheelchairs.

### BACKGROUND OF THE INVENTION

Wheelchairs have long provided a means of locomotion for disabled individuals. Unfortunately, conventional wheelchairs are constructed from a “one size fits most” standpoint, making them uncomfortable for large or small individuals to use. While fully adjustable wheelchair designs have been proposed to accommodate people of varied size, these designs have not seen widespread use and great commercial success. Perhaps the complex and cumbersome nature of the known wheelchair designs incorporating adjustable features has been their principal drawback.

### SUMMARY OF THE INVENTION

In light of the problems associated with the known wheelchairs, it is a principal object of the invention to provide a wheelchair of uncomplicated construction that can be adjusted to accommodate any user. In the preferred embodiment, the positioning of the seat, chair arms and footrest can be separately changed. Such changes can be performed intuitively, without specialized instruction and without tools of any sort.

It is another object of the invention to provide a wheelchair of the type described that is fully collapsible for compact storage. When in a collapsed condition, the wheelchair can be wheeled about in the manner of a dolly to a convenient place of rest. Opening the collapsed wheelchair for subsequent use may be accomplished in a matter of seconds.

It is a further object of the invention to provide a wheelchair of the type described that can be manually powered or can be adapted, if desired, for locomotion by means of one or more motors.

It is an object of the invention to provide improved elements and arrangements thereof in a wheelchair for the purposes described that is lightweight in construction, inexpensive to manufacture, and fully dependable in use.

Briefly, the wheelchair in accordance with this invention achieves the intended objects by featuring a collapsible frame including a forward portion hingedly secured to a rearward portion such that the frame can be opened with the forward portion is oriented substantially at right angles to the rearward portion and collapsed with the forward portion oriented substantially parallel to the rearward portion. The frame rides on a pair of casters secured to the forward portion and a pair of drive wheels secured to the rearward portion. A user is supported by a seat secured to the forward portion and a backrest secured to the rearward portion.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a side elevational view of a wheelchair in accordance with the present invention.

FIG. 2 is a side elevational view of the wheelchair of FIG. 1 in a partially collapsed condition.

FIG. 3 is a side elevational view of the wheelchair in a fully collapsed condition.

FIG. 4 is a top plan view of the wheelchair.

FIG. 5 is a front elevational view of the wheelchair.

FIG. 6 is a rear elevational view of the wheelchair.

FIG. 7 is a bottom plan view of the wheelchair.

FIG. 8 is a perspective view of a portion of the frame of the wheelchair showing details thereof.

Similar reference characters denote corresponding features consistently throughout the accompanying drawings.

### DETAILED DESCRIPTION OF THE PREFERRED EMBODIMENT

Referring now to the FIGS., a wheelchair in accordance with the present invention is shown at 10. Wheelchair 10 includes a collapsible frame 12 with a forward portion 14 secured by means of a pair of hinges 16 to a rearward portion 18. A pair of casters 20 is secured to the front of forward portion 14 and a pair of drive wheels 22 is secured to the rear of rearward portion 18 to stably support frame 12 at a fixed height above the ground. A cushioned seat 24 is secured atop forward portion 14 whereas a cushioned backrest 26 is secured to rearward portion 18 to support a user in comfort on frame 12. A pair of armrests 28 extends upwardly from the opposite sides of forward portion 14 and a footrest 30 extends forwardly from forward portion 14 for added comfort.

Forward portion 14 has a pair of side rails 32 joined together by a crosspiece 34 so as to form a rigid structure. Secured to the inner surfaces of side rails 32 is a first pair of socket members 36 for receiving a pair of posts 38 at the front of seat 24. A second pair of socket members 40 is secured to the inner surfaces of side rails 32 rearwardly of socket members 36 for receiving a pair of upwardly extending legs 42 comprising footrest brace 44.

Rearward portion 18 includes a pair of side members 46 connected at their tops by an arcuate crossbar 48 that serves as a handle for pushing wheelchair 10 from behind. Beneath crossbar 48, a pair of crossbars 50 and 52 connects side members 46 at spaced intervals and further reinforce rearward portion 18. A pair of mounting bosses 54 extends forwardly from the bottoms of side members 46 and abuts side rails 32 of forward portion 14. Secured to the inner surfaces of bosses 54 is a third pair of socket members 56 for receiving pins 38 at the rear of seat 24.

Hinges 16 connect the side rails 32 to mounting bosses 54. As shown, hinges 16 permit forward portion 14 to pivot upwardly relative to rearward portion 18 so that both may be oriented substantially parallel to one another as illustrated in FIG. 3. Affixed to the fronts of mounting bosses 54 beneath hinges 16 is a pair of locking plates 58. Locking plates 58 extend forwardly from bosses 54 to which such are rigidly affixed and have transverse apertures 60 that may be brought into registry with transverse apertures 62 in the rears of side rails 32. Locking pins 64 passed through the registered apertures 60 and 62 maintain wheelchair 10 in an open condition for use as illustrated in FIG. 1.

Seat 24 is generally rectangular in outline and is provided with a downwardly extending post 38 in each of its four corners. Each post 38 is provided with a plurality of transverse apertures 66, each being adapted for registry with a transverse aperture 68 in one of the socket members 36 or 56. Locking pins 70 passed through the registered apertures 66 and 68 maintain seat 24 at a desired height above forward portion 14. Thus, a user can adjust the height of seat 24 to meet his needs.

Backrest 26 is shown, for the sake of drawing simplicity, to be permanently attached to rearward portion 18. It should be appreciated, however, that backrest 26 could be attached to rearward portion 18 in the same manner as seat 24 is attached to forward portion 14, i.e., with pins passing through posts and socket members. Such an arrangement, of course, would permit the position of backrest 26 to be adjusted forward and back to accommodate the desires of a user.

An armrest supporting brace 72 is secured to forward portion 14. Brace 72 has a pair of armrest supporting posts 74 joined at their bottoms by a tie bar 76. As shown, bar 76 is adapted to engage the bottoms of sides rails 32 whereas posts 74 are adapted to engage the outer surfaces of side rails 32 and to extend upwardly therefrom. The bottom of each post 74 is provided with a transverse aperture 78 adapted for registry with one of a plurality of transverse apertures 80 arrayed along each side rail 32. Locking pins 82 passed through registered apertures 78 and 80 set the position of posts 74 forward or back relative to rearward portion 18.

Each armrest 28 includes a cushioned arm support 84 positioned atop a tubular sleeve 86. Each sleeve 86 is configured for snug, yet slidable, positioning upon a post 74. As shown, each sleeve 86 is provided with a plurality of transverse apertures 88, each adapted for registry with a transverse aperture 90 in a post 74. A locking pin 92 passed through registered apertures 88 and 90 maintains cushioned support 84 at a desired height above seat 24. Thus, the construction of wheelchair 10 permits a user to move armrests 28 not only up and down but also forward and back.

Footrest brace 44 is secured to forward portion 14. Brace 44 has a pair of legs 42 joined at their bottoms by a tie bar 76. Tie bar 76 is provided with a longitudinal opening 94 at its center for slidably receiving footrest 30. Legs 42, however, are adapted for insertion into socket members 40. The top of each leg 42 is provided with a plurality of transverse apertures 96 adapted for registry with a transverse aperture 98 penetrating each socket member 40. Locking pins 100 passed through registered apertures 96 and 98 set the height of tie bar 76 relative to forward portion 14.

Footrest 30 includes a spar 102 having a cushioned support 104 secured to its front. Spar 102 is provided with a plurality of transverse apertures 106 adapted for registry with a transverse aperture 108 penetrating tie bar 76 and opening 94. A locking pin 110 passed through registered apertures 106 and 108 permits the extension of support 104 forward of forward portion 14 to be adjusted by a user.

From the foregoing, it should be appreciated that use of wheelchair 10 is straightforward. First, the height of seat 24 is adjusted by withdrawing pins 70 (if necessary), repositioning posts 38 in socket members 36 and 56 and reinserting pins 70 in apertures 66 and 68. Next, similar adjustments are made to the heights armrests 28 and footrest 30. A person positioned in wheelchair 10 can, now, be moved about in complete comfort.

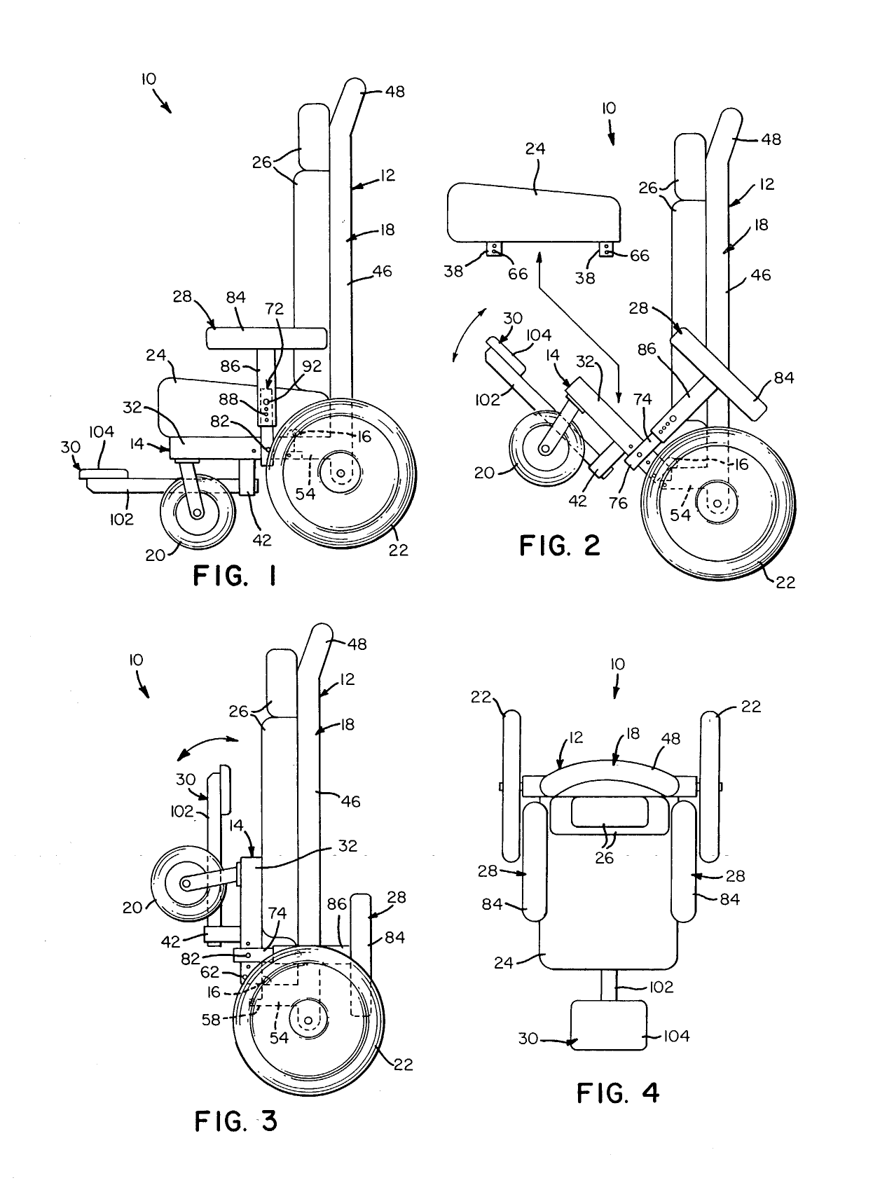

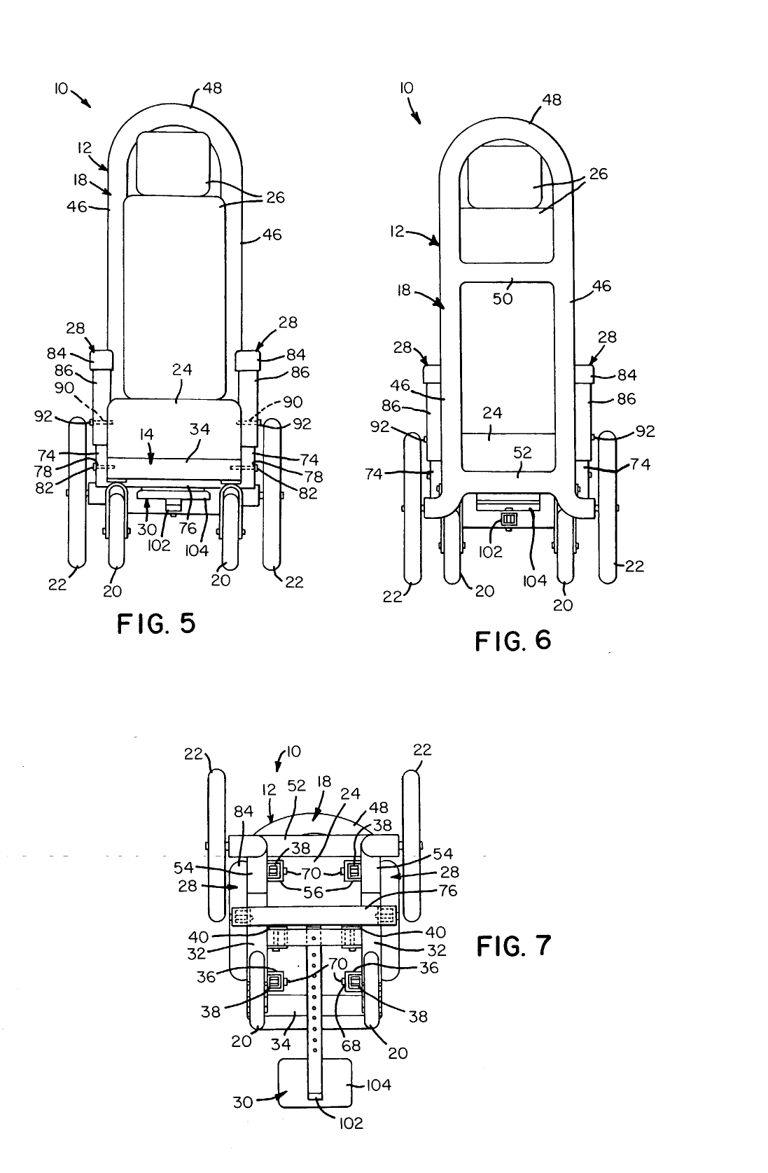

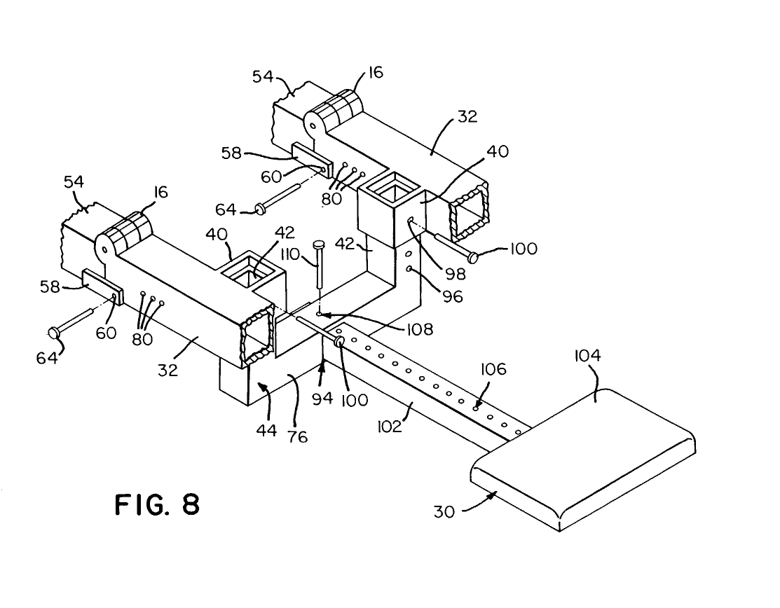

When use of wheelchair 10 is no longer required, it may be collapsed in stages as illustrated in FIGS. 1-3 for compact storage. First, pins 70 are withdrawn from socket members 36 and 56 and seat 24 is removed from frame 12. Then, pins 64 are removed from plates 58 thereby permitting forward and rearward portions 14 and 18 to pivot toward one another as illustrated in FIG. 2. Further pivoting results in forward portion 14 pressing against backrest 26. A strap (not shown) may be wrapped around portions 14 and 18 to retain wheelchair in a collapsed condition as long as is desired. Wheelchair 10 may be moved to a convenient location like a closet for storage simply by grasping crossbar 48 and steering wheelchair 10 in the manner of a dolly.

While the invention has been described with a high degree of particularity, it will be appreciated by those skilled in the art that modifications may be made thereto. For example, the cushioned support 104 of footrest 30, shown as being rigidly affixed to spar 102, can be made to pivot by a variety of conventional means to provide greater comfort to a user. Furthermore, the wheelchair 10, shown as being manually powered principally to avoid obscuring important details of the construction of frame 12 thereof, can be outfitted with one or more electric motors, batteries and control apparatus to permit wheelchair 10 to move over the ground under its own power. Therefore, it is to be understood that the present invention is not limited to the sole embodiment described above, but encompasses any and all embodiments within the scope of the following claims.

I claim:

1. A wheelchair, comprising:
a collapsible frame including a forward portion hingedly secured to a rearward portion, said frame being selectively movable between an open state and a collapsed state whereby when said frame is in the open state said forward portion is oriented substantially at right angles to said rearward portion and when said frame is in the collapsed state said forward portion is oriented substantially parallel to said rearward portion;
a pair of casters secured to said forward portion;
a pair of drive wheels secured to said rearward portion;
a seat secured to said forward portion; and,
a backrest secured to said rearward portion.

2. The wheelchair according to claim 1 wherein:
said forward portion and said rearward portion of said frame each include a plurality of socket members, each of said socket members having a first transverse aperture;
said seat includes a plurality of posts projecting downwardly therefrom and being adapted for positioning within said socket members, each of said posts having a plurality of second transverse apertures adapted for selective alignment with said first transverse aperture in a respective one of said socket members; and,
said wheelchair further comprises a plurality of locking pins that can be passed through said first and second transverse apertures when brought into registration with one another so that the height of said seat can be selectively fixed.

3. The wheelchair according to claim 1 wherein:
said forward portion is provided with a plurality of first transverse apertures in the opposed sides thereof; and,
said wheelchair further comprises:
an armrest supporting brace movably secured to said forward portion of said collapsible frame, said armrest supporting brace including:
a pair of armrest supporting posts slidably engaging the opposed sides of said forward portion and extending upwardly therefrom, the bottom of each armrest supporting post being provided with a second transverse aperture adapted for selective alignment with one of said first transverse apertures in one of the opposed sides of said forward portion, the top of each armrest supporting post being provided with a third transverse aperture;
a tie bar connecting the bottoms of said armrest supporting posts and slidably engaging the bottom of said forward portion of said collapsible frame;
a pair of first locking pins for positioning within said first and second transverse apertures when such are aligned with one another so that the positioning of said armrest supporting posts relative to said rearward portion of said collapsible frame can be selectively fixed;
a pair of armrests each including a cushioned arm support positioned atop a tubular sleeve adapted for slidable positioning upon one of said armrest supporting posts, each tubular sleeve is provided with a plurality of fourth transverse apertures each being adapted for alignment with one said third transverse aperture; and,
a pair of second locking pins that can be passed through said third and fourth transverse apertures when such are aligned with one another so that the height of said cushioned arm supports above said forward portion can be selectively fixed.

4. The wheelchair according to claim 1 further comprising:
a pair of socket members secured to said forward portion, each of said socket members having a first transverse aperture;
a footrest brace movably secured to said forward portion, said footrest brace including:
a pair of legs adapted for insertion into said socket members; the top of each of said legs being provided with a plurality of second transverse apertures adapted for alignment with said first transverse aperture in a respective one of said socket members,
a tie bar having a longitudinal opening in its center and joining the bottoms of said legs together, said tie bar being provided with a third transverse aperture passing through said longitudinal opening;
a pair of first locking pins for positioning within said first and second transverse apertures when such are aligned with one another so that the height of said tie bar relative to said forward portion of said collapsible frame can be selectively fixed;
a footrest including:
a spar slidably positioned within said longitudinal opening in said tie bar, said spar being provided with a plurality of third transverse apertures positioned along its length and being adapted for alignment with said third transverse aperture;
a cushioned support secured to the front of said spar; and,
a second locking pin for positioning within said third and fourth transverse apertures when such are aligned with one another so that the positioning of said cushioned support relative to said forward portion of said collapsible frame can be selectively fixed.
